(19) United States
(12) Patent Application Publication
(10) Pub. No.: US 2013/0149427 A1
(43) Pub. Date: Jun. 13, 2013

(54) Method of Preparing Flour or Splits of Legume

(71) Applicants: Eliana Zamprogna, Winterthur (CH); Stefania Bellaio, Valdobbiadene (IT); Michael Jacobs, St. Gallen (CH); Béatrice Conde-Petit, Zurich (CH); Urs Keller, Seuzach (CH); Dipak Balasaheb Mane, Bangalore (IN); Marcel Natterer, Wil (CH)

(72) Inventors: Eliana Zamprogna, Winterthur (CH); Stefania Bellaio, Valdobbiadene (IT); Michael Jacobs, St. Gallen (CH); Béatrice Conde-Petit, Zurich (CH); Urs Keller, Seuzach (CH); Dipak Balasaheb Mane, Bangalore (IN); Marcel Natterer, Wil (CH)

(73) Assignee: BÜHLER AG, Uzwil (CH)

(21) Appl. No.: 13/702,053

(22) PCT Filed: Apr. 13, 2011
(86) PCT No.: PCT/EP2011/055801

§ 371 Date: Jan. 15, 2013

(30) Foreign Application Priority Data
Jun. 4, 2010 (IN) 1310/DEL/2010

(51) Int. Cl. A23L 1/20; A23L 1/211

(52) U.S. Cl. CPC A23L 1/2005; A23L 1/211
USPC 426/634; 426/419; 99/537; 29/401.1

(57) ABSTRACT

A method of preparing flour or splits of legume according to the invention comprises the steps of: i) providing legume; ii) allowing the legume to partially germinate; iii) optionally, terminating germination of the legume; iv) preparing the partially germinated legume for milling; v) optionally, milling the prepared legumes of step iv). Partial germination was found—besides increasing the content of nutrients and decreasing the content of antinutrients to enhance the physical quality of splits and to enhance the dehusking yield. Moreover, nutritionally more beneficial flour and splits can be provided.

The present invention pertains to the field of food technology, in particular to the field of legume processing technology.

Despite the improvement of the living conditions, population of newly industrializing countries still is often severely harmed by health problems related to malnutrition. In its most recent study, the FAO (Food and Agriculture Organization of the United Nations) estimates that more than 1 billion people are undernourished worldwide in 2009. This represents more hungry people than at any time since 1970. Nearly all of the undernourished people are living in developing countries and newly industrializing countries, particularly in the Asian and Pacific region, with India and China being the most affected countries. Governments and institutions are becoming aware of the dramatic impact of these problems on the country economy and security. For example, in India over 50% of preschool children and 30% adults are undernourished and over 70% of women and children suffer from iron deficiency anemia (data of 2009). In the meantime, post-transition life-style related diseases like obesity and chronic degenerative diseases are increasing, with India becoming world capital of diabetes. Over 10% of the Indians are overweight or obese, the incidence being almost 20% in urban areas. Apart from human suffering caused due to morbidity and mortality, malnutrition is severely denting India's productivity and development, and adding to medical expenditure.

Countrywide diet surveys in India show that most of the malnutrition problems in India and in other developing or newly industrializing countries (the so-called “hidden hunger”) are due to the dietary deficiency in vitamins and minerals, such as iron, vitamin A, and some vitamins of the B-group, particularly riboflavin (B₂) and folic acid (B₉). Insufficient intake of vitamin C (ascorbic acid) is also an important issue, since vitamin C is essential to the absorption of iron. These deficiencies can be ascribed to the low intake of foods like vegetables, fruits, and foods of animal origin. Nutritious meals are disappearing within the family diet of preschool children and are inadequate due to ignorance and time constraint on families, particularly in the urban regions.

Grains such as maize, wheat, rice and legumes are affordable staple food for most of the world population and are the basis of the global food production. Yearly, 820 million tons of corn, 380 million tons of brown rice, 550 million tons of wheat and 60 million tons of legumes are produced worldwide and are consumed as such or transformed into flour and food products, such as breads or noodles. Through their high content of starch and storage proteins, these grains are the most important source of energy for the global population. However, grains are known to be poor in micronutrients content, such as iron and vitamins. Micronutrients are chemical elements that are required by living organisms in tiny quantities only, also known as trace elements; as understood herein, the term is extended to organic compounds such as vitamins (Oxford Dictionary of Biochemistry and Molecular Biology, Oxford University Press, 2006, ISBN0198529171, p 426). Moreover, antinutrients are present in grains and limit grain digestibility and bioavailability of iron and vitamins. Antinutrients are natural compounds that interfere with the absorption of nutrients; one example is phytic acid, which forms insoluble complexes with calcium, zinc, iron and copper (Oxford Dictionary of Biochemistry and Molecular Biology, Oxford University Press, 2006, ISBN0198529171, p 47).

From IN1530DEL2006 it is known to germinate pulses for at least 48-96 hours and to subsequently use such sprouts freeze-dried. However, this document is not all concerned with providing splits or flour.

US 2008/0286435 describes a method to increase the content of GABA (γ-aminobutyric acid) in grain or legume. The increase of the GABA content is achieved by subjecting the legume to stress, explicitly without any germination of the legume to occur.

It is an object of the present invention to provide nutritionally improved splits and/or flour of legume, while at the same time allowing for most efficient industrial applicability of the underlying production method.

This object is solved by a method of preparing flour or splits of legume, as follows.

According to the invention, a method of preparing flour or splits of legume comprises the steps of:

i) providing legume;
ii) allowing the legume to partially germinate;
iii) optionally, terminating germination of the legume;
iv) preparing the partially germinated legume for milling;
v) optionally, milling the prepared legumes of step iv).

Legume in botanical writing is a plant in the family Fabaceae (or Leguminosae); as understood herein, legume is the fruit of such plants. Such legume fruit is a dry fruit that develops from a simple carpel and usually dehisces (opens along a seam) on two sides.

Preferred legumes provided in step i) in the context of the present invention are chosen from the group consisting of forage legumes (e.g. lucerne, clovers or alfalfa) and grain legumes (e.g. green beans/peas, soybeans, peanuts or pulses). Most preferably, pulses are used in the context of the present invention. Pulses, as used herein, are (adapted from FAO):

TABLE 1

| | |
|---|---|
| 0176 | BEANS, DRY |
| | Phaseolus spp.: kidney, haricot bean (Ph. vulgaris); lima, |
| | butter bean (Ph. lunatus); adzuki bean (Ph. angularis); |
| | mungo bean, golden, green gram (Ph. aureus); black gram, |
| | urd (Ph. mungo); scarlet runner bean (Ph. coccineus); rice |
| | bean (Ph. calcaratus); moth bean (Ph. aconitifolius); |
| | tepary bean (Ph. acutifolius) |
| 0181 | BROAD BEANS, DRY |
| | Vicia faba: horse-bean (var. equina); broad bean (var. |
| | major); field bean (var. minor) |
| 0187 | PEAS, DRY |
| | garden pea (Pisum sativum); field pea (P. arvense) |
| 0191 | CHICK-PEAS |
| | chickpea, Bengal gram, garbanzos (Cicer arietinum) |
| 0195 | COW PEAS, DRY |
| | cowpea, blackeye pea/bean (Vigna sinensis; Dolichos |
| | sinensis) |
| 0197 | PIGEON PEAS |
| | pigeon pea, cajan pea, Congo bean (Cajanus cajan) |
| 0201 | LENTILS |
| | (Lens esculenta; Ervum lens) |
| 0203 | BAMBARA BEANS |
| | bambara groundnut, earth pea (Voandzeia subterranea) |
| 0205 | VETCHES |
| | spring/common vetch (Vicia sativa) |
| 0210 | LUPINS |
| | (Lupinus spp.) |
| 0211 | PULSES NES |
| | Including inter alia: lablab or hyacinth bean (Dolichos |
| | spp.); jack or sword bean (Canavalia spp.); winged bean |
| | (Psophocarpus tetragonolobus); guar bean (Cyamopsis |
| | tetragonoloba); velvet bean (Stizolobium spp.); yam bean |
| | (Pachyrrhizus erosus); |

A key aspect of the method according to the invention is step ii). Germination is a natural process which refers to the first stage of the growth of a plant from a seed. Germination involves the imbibition of water into the legume, the reactivation of its metabolism and the initiation of biochemical processes which allow the embryo in the seed to develop. Profound changes in the nutritive value take place: the digestibility of macronutrients such as protein and starch is increased, micronutrients like minerals and vitamins become available, antinutrients, such as trypsin inhibitor, phytic acid and/or phenolic compounds, are inactivated, and texture and flavour are positively developed. Germination as such is a well known traditional process widely applied throughout the world. However, to the best of applicant's knowledge, no partial germination has ever been proposed in order to subsequently prepare flour or splits of such partially germinated legume, not to mention on an industrial scale. Quite to the contrary, germination apparently has only been proposed in order to provide fully developed sprouts (by e.g. soaking in water, followed by 3 to 4 days germination, long sprouts are visible). This leads to pronounced structural and biochemical changes in the seed. The nutritional claims for fully germinated pulses are well substantiated in the scientific literature. However, full germination implies remarkable grain losses in form of rootlets and germs. Towards this end, the present invention for the first time provides a method that balances the beneficial effects of germination on the one hand, while at the same time assuring advantageous physical and biochemical properties of the legume in order to prepare flour or splits of legume. This is done by not allowing the legume to fully germinate, but to only partially germinate. The beneficial trade-off of germination effects on the one hand and physical properties of the splits on the other hand will be outlined henceforth in more detail.

The legume may be cleaned prior to being provided in step i). Cleaning of the legume can be done by standard cleaning procedures known in the milling industry such as e.g. destoning, separation of immature grains, sieving, grading.

Preferably, the partial germination in step ii) is carried out for a time and under conditions sufficient to allow for at least one antinutrient, in particular trypsin inhibitor, phytic acid and/or phenolic compounds, to decrease by about 5% to about 90%, preferably by about 5% to about 60%, most preferably by about 5% to about 40%.

Trypsin inhibitor activity may be determined by the method of Hamerstarnd et al. Phytic acid may be determined as phytin-phosphorous (multiplying the phytin phosphorous value by 3.55) by the method of Thompson and Erdman (1982). Phenolic compounds may be determined as tannin. Tannin was estimated by the modified vanillin assay of Price et al. (1978), using catechin as the standard.

In particular preferred embodiments, the partial germination in step ii) is carried out for a time and under conditions sufficient to allow for ROF to decrease by at least about 30% (compared to the legume as initially provided in step i)). In some embodiments, the partial germination in step ii) may be carried out for a time and under conditions sufficient to allow for ROF to decrease by at most about 90% (compared to the legume as initially provided in step i)). In certain other embodiments, the partial germination in step ii) may be carried out for a time and under conditions sufficient to allow for ROF to decrease by up to 100% (compared to the legume as initially provided in step i)).

ROF, as understood herein, is the raffinose oligosaccharides family, i.e. the α-galactosyl derivatives of sucrose; for the purpose of the present invention, the most common trisaccharide raffinose and the tetrasaccharide stachyose are taken into account. Humans do not possess the α-GAL enzyme to break down ROFs and these oligosaccharides pass undigested through the stomach and upper intestine. In the lower intestine, they are fermented by gas-producing bacteria which do possess the α-GAL enzyme and make carbon dioxide, methane, and/or hydrogen, leading to the flatulence commonly associated with eating beans and other vegetables.

In further preferred embodiments, the partial germination in step ii) is carried out for a time and under conditions sufficient to result in an ROF content of about 0.1 g to about 3.0 g per 100 g dry mass, in case of the legume being pulse. Specifically, the partial germination in step ii) is carried out for a time and under conditions sufficient to result in an ROF content of

about 0.8 g to about 1.6 g, preferably about 0.8 g to about 1.4 g, most preferably about 0.8 g to about 1.2 g per 100 g dry mass, in case of the legume being chickpea (measurement method as defined hereinbelow in item 0);

about 0.6 g to about 1.6 g, preferably about 0.6 g to about 1.4 g, most preferably about 0.6 g to about 1.2 g per 100 g dry mass, in case of the legume being black bean (measurement method as defined hereinbelow in item 0);

about 1.2 g to about 2.6 g, preferably about 1.2 g to about 2.4 g, most preferably about 1.2 g to about 2.2 g per 100 g dry mass, in case of the legume being soybean (measurement method as defined hereinbelow in item 0);

about 0.1 g to about 0.5 g, preferably about 0.1 g to about 0.4 g, most preferably about 0.1 g to about 0.3 g per 100 g dry mass, in case of the legume being beans (Phaseolus vulgaris) (measurement method as defined in item 0);

about 0.1 g to about 1.0 g, preferably about 0.1 g to about 0.6 g, most preferably about 0.1 g to about 0.3 g per 100 g dry mass, in case of the legume being lentils (measurement method as defined in item 0);

about 0.1 g to about 1.5 g, preferably about 0.1 g to about 1.0 g, most preferably about 0.1 g to about 0.5 g per 100 g dry mass, in case of the legume being peas (Pisum sativum) (measurement method as defined in item 0);

about 1.0 g to about 3.0 g, preferably about 1.5 g to about 3.0 g, most preferably about 2.0 g to about 3.0 g per 100 g dry mass, in case of the legume being pulse green gram (measurement method as defined in item 0).

In yet further preferred embodiments, the partial germination in step ii) is carried out for a time and under conditions sufficient to result in a bioavailability of minerals of the legume

in the range of about 15% to about 35%, preferably about 15% to about 25%, most preferably about 15% to about 20% of total iron, in case of the mineral being iron and the legume being pulse, preferably chickpea, green gram, cowpea or lentil (measurement method as defined hereinbelow in items 0, 0, 0 and 0, respectively); and/or

in the range of about 75% to about 95%, preferably about 75% to about 90%, most preferably about 75% to about 85% of total zinc, in case of the mineral being zinc and the legume being pulse, preferably pigeon pea (measurement methods as defined hereinbelow in item 0).

The content of iron and/or zinc may be determined, for example, by using standard AOAC atomic absorption spectroscopy method 944.02. Bioaccessible iron, zinc and calcium in vitro digestion may be determined with the following method, as suggested by Hemalatha et al. (European Journal of Clinical Nutrition (2007) 61, 342-348): finely ground grain samples were asked in a muffle furnace at 550° C. for 5 h and dissolved in concentrated HCl. Zinc and iron content were determined by atomic absorption spectrometry (Shimadzu AAF-6701). Calibration of measurements was performed using commercial standards. All measurements were carried out under standard flame operating conditions as recommended by the manufacturer. The reproducibility values were within 2.0% for both zinc and iron.

Bioaccessibility of zinc and iron in various food grain samples was determined by an in vitro method described by Luten et al. (1996) involving simulated gastrointestinal digestion with suitable modifications. The samples were finely ground in a stainless steel wearing blender and then subjected to gastric digestion by incubation with pepsin (pH 2.0) at 37° C. for 2 h. Titratable acidity was measured in an aliquot of the gastric digest by adjusting the pH to 7.5 with 0.2M sodium hydroxide in the presence of pancreatin-bile extract mixture (110.1M sodium bicarbonate containing 4 g pancreatin+25 g bile extract). The titratable acidity was defined as the amount of 0.2M sodium hydroxide required to attain a pH of 7.5. To simulate intestinal digestion, segments of dialysis tubing (Molecular mass cutoff: 10 kDa) containing 25 ml sodium bicarbonate solution, being equivalent in moles to the NaOH needed to neutralize the gastric digest (titratable acidity) determined as above, were placed in Erlenmeyer flasks containing the gastric digest and incubated at 37° C. with shaking for 30 min or longer until the pH of the digest reached 5.0. Pancreatin-bile extract mixture (5 ml) was added and incubation was continued for 2 h or longer until the pH of the digest reached 7.0. At the end of simulated gastro-intestinal digestion, zinc and iron present in the dialyzate, which represents bio-available trace elements, were analyzed by atomic absorption spectrometry.

In yet further preferred embodiments, the partial germination in step ii) is carried out for a time and under conditions sufficient to result in a protein digestibility of the legume in the range of about 70% to about 90%, preferably about 70% to about 85%, most preferably about 70% to about 80%, in case of the legume being pulse, preferably chickpea, green gram, cowpea or lentil (measurement methods as defined hereinbelow in items 0, 0, 0 and 0, respectively)).

In further advantageous embodiments, the partial germination in step ii) is carried out for a time and under conditions sufficient to allow for an increase in vitamin content of the legume

in case of the legume being chickpea (measurement method as defined hereinbelow in item 0):

by about 20% to about 60% in case of vitamin B₁, and/or

to a content of vitamin B₁ in the range of about 0.40 mg/100 g d.m. to about 0.55 mg/100 g d.m., preferably about 0.40 mg/100 g d.m. to about 0.50 mg/100 g d.m., most preferably to about 0.40 mg/100 g d.m. to about 0.45 mg/100 g d.m.;

and/or

in case of the legume being green gram (measurement method as defined hereinbelow in item 0): to a content of vitamin B₁ in the range of about 0.60 mg/100 g d.m. to about 0.85 mg/100 g d.m., preferably about 0.60 mg/100 g d.m. to about 0.80 mg/100 g d.m., most preferably to about 0.60 mg/100 g d.m. to about 0.75 mg/100 g d.m.;

and/or

in case of the legume being cowpea (measurement method as defined hereinbelow in item 0): to a content of vitamin B₁ in the range of about 0.66 mg/100 g d.m. to about 0.85 mg/100 g d.m., preferably about 0.66 mg/100 g d.m. to about 0.80 mg/100 g d.m., most preferably to about 0.66 mg/100 g d.m. to about 0.75 mg/100 g d.m.;

and/or

in case of the legume being lentil (measurement method as defined hereinbelow in item 0): to a content of vitamin B₁ in the range of about 0.60 mg/100 g d.m. to about 0.85 mg/100 g d.m., preferably about 0.60 mg/100 g d.m. to about 0.80 mg/100 g d.m., most preferably to about 0.60 mg/100 g d.m. to about 0.75 mg/100 g d.m.;

and/or

in case of the legume being lentil (measurement method as defined hereinbelow in item 0);

by about 10% to about 30% in case of vitamin B₂, and/or

to a content of vitamin B₂ in the range of about 0.22 mg/100 g d.m. to about 0.30 mg/100 g d.m., preferably about 0.22 mg/100 g d.m. to about 0.28 mg/100 g d.m., most preferably to about 0.22 mg/100 g d.m. to about 0.26 mg/100 g d.m.;

and/or

in case of the legume being beans (Phaseolus vulgaris) (measurement method as defined hereinbelow in item 0): to a content of vitamin B₂ in the range of about 0.30 mg/100 g d.m. to about 0.38 mg/100 g d.m., preferably about 0.30 mg/100 g d.m. to about 0.36 mg/100 g d.m., most preferably to about 0.30 mg/100 g d.m. to about 0.34 mg/100 g d.m.;

and/or

in case of the legume being peas (Pisum sativum) (measurement method as defined hereinbelow in item 0): to a content of vitamin B₂ in the range of about 0.20 mg/100 g d.m. to about 0.40 mg/100 g d.m., preferably about 0.20 mg/100 g d.m. to about 0.35 mg/100 g d.m., most preferably to about 0.20 mg/100 g d.m. to about 0.30 mg/100 g d.m.;

and/or

in case of the legume being chickpea (measurement method as defined hereinbelow in item 0):

by about 100% to about 700% in case of vitamin C, and/or

to a content of vitamin C in the range of about 5 mg/100 g d.m. to about 25 mg/100 g d.m., preferably about 5 mg/100 g d.m. to about 20 mg/100 g d.m., most preferably to about 5 mg/100 g d.m. to about 15 mg/100 g d.m.

Vitamins content may be determined using standard HPLC methods, for example the AOAC HPLC methods 953.17, 970.65 and 984.26.

In preferred embodiments, in which the legume is brown chickpea, the partial germination in step ii) is carried out for a time and under conditions sufficient to result
a) in a decrease in ROF content of the legume
   by about 30% to about 100%, and/or to a content in the range of about 3 g/100 g d.m. to about 0 g/100 g d.m., preferably about 2 g/100 g d.m. to about 0 g/100 g d.m., most preferably to about 1 g/100 g d.m. to about 0 g/100 g d.m;
and/or
b) in an increase in bioavailability of iron contained in the legume
   in the range of about 15% to about 300%, preferably about 50% to about 300%, most preferably about 100% to about 300%, and/or to a content in the range of about 0.8 g/100 g d.m. to about 2.0 g/100 g d.m., preferably about 0.9 g/100 g d.m. to about 2.0 g/100 g d.m., most preferably to about 1.0 g/100 g d.m. to about 2.0 g/100 g d.m.;
and/or
c) in an increase in bioavailability of zinc contained in the legume
   in the range of about 10% to about 150%, preferably about 30% to about 150%, most preferably about 50% to about 150%, and/or to a content in the range of about 0.6 g/100 g d.m. to about 2.0 g/100 g d.m., preferably about 0.65 g/100 g d.m. to about 2.0 g/100 g d.m., most preferably to about 0.7 g/100 g d.m. to about 2.0 g/100 g d.m.;
and/or
d) in an increase in protein digestibility of the legume in the range of about 70% to about 90%, preferably about 70% to about 85%, most preferably about 70% to about 80%;
and/or
e) in an increase in the vitamin B₁ content of the legume by about 20% to about 600%, and/or
   to a content in the range of about 0.30 mg/100 g d.m. to about 1.3 mg/100 g d.m., preferably about 0.40 mg/100 g d.m. to about 1.3 mg/100 g d.m., most preferably to about 0.50 mg/100 g d.m. to about 1.3 mg/100 g d.m.;
and/or
f) in an increase in the vitamin B₂ content of the legume by about 5% to about 30%; and/or
   to a content in the range of about 0.12 mg/100 g d.m. to about 0.2 mg/100 g d.m., preferably about 0.13 mg/100 g d.m. to about 0.2 mg/100 g d.m., most preferably to about 0.14 mg/100 g d.m. to about 0.2 mg/100 g d.m.;
and/or
g) in an increase in the vitamin C content of the legume by about 100% to about 700%; and/or
   to a content in the range of about 4 mg/100 g d.m. to about 28 mg/100 g d.m., preferably about 6 mg/100 g d.m. to about 28 mg/100 g d.m., most preferably to about 8 mg/100 g d.m. to about 28 mg/100 g d.m.

As used herein, the abbreviation “d.m.” refers to the dry mass.

It has been found useful that step ii) of allowing the legume to partially germinate comprises the sub-steps of:

a) soaking the legume in an aqueous medium, preferably water;
b) conditioning the soaked legume.

The sub-step a) of soaking the legume in an aqueous medium, preferably water, is preferably carried out under conditions chosen from the group consisting of:

a volume of water being added in the range of about 1 to about 6 volumes of the legumes, preferably about 1 to about 4 volumes, most preferably about 1 to about 3 volumes; and/or

a temperature in the range of about 20° C. to about 50° C., preferably about 25° C. to about 50° C., most preferably about 25° C. to about 35° C.; and/or

for about 1 h to about 24 h, preferably about 1 h to about 18 h, most preferably about 1 h to about 12 h.

During sub-step a), the legume is preferably completely immersed in the aqueous medium. The “volume” of the legume is to be understood as the bulk volume, i.e. as to also comprise the free volume of the close-packing of the legume.

In between sub-steps a) and b), excess aqueous medium is drained off e.g. by simple discharge through a fence onto which the partially germinated legume is provided.

Thereafter, the sub-step b) of conditioning the soaked legume is preferably carried out under conditions chosen from the group consisting of:

a temperature in the range of about 20° C. to about 50° C., preferably about 25° C. to about 40° C., most preferably about 25° C. to about 35° C.; and/or

a relative atmospheric humidity of about 30% to about 90%, preferably about 40% to about 90%, most preferably about 50% to about 90%; and/or

for about 3 h to about 48 h, preferably about 6 h to about 36 h, most preferably about 6 h to about 24 h.

With respect to step iii) of terminating germination of the legume, this step is advantageously carried out by a method chosen from the group consisting of freezing; drying, preferably air-drying, freeze-drying, roasting, infrared roasting, vacuum-drying, microwave-drying, infrared drying, or any combination thereof; modifying the ambient atmosphere.

Methods of conserving foodstuff in modified atmosphere packages are known as such and can be applied in the context of the present invention in analogous manner, i.e. by subjecting the partially germinated legume to the respective atmospheric conditions as e.g. discussed by Fonseca et al., Journal of Food Engineering 52 (2002), 99-119 (incorporated herein by reference with respect to suitable atmospheric conditions for step iii)).

In accordance with preferred embodiments, drying is carried out under conditions chosen from the group consisting of:

an air-temperature in the range of about 30° C. to about 100° C., preferably about 40° C. to about 80° C., most preferably about 40° C. to about 70° C., in particular when drying is performed by air-drying; and/or

a relative atmospheric humidity of about 5% to about 50%, preferably about 5 to about 40%, most preferably about 5 to about 30%; and/or

about 1 h to about 48 h, preferably about 1 h to about 36 h, most preferably about 1 h to about 24 h; and/or

when drying is performed by roasting:
in a first step: at a temperature between about 50° C. and about 120° C. for about 1 h to about 36 h, in a second step: at a temperature between about 120° C. and about 200° C., preferably between about 150° C. and about 180° C., for about 5 min to about 90 min, preferably for about 10 min to about 30 min.

Step iv) of preparing the partially germinated legume for milling preferably comprises the sub-steps of:

dehusking;

splitting;

optionally roasting, preferably in a two-step process:
in a first step: at a temperature between about 50° C. and about 120° C. for about 1 h to about 36 h, in a second step: at a temperature between about 120° C. and about 200° C., preferably between about 150° C. and about 180° C., for about 5 min to about 90 min, preferably for about 10 min to about 30 min.

These steps are known as such in the art.

Yet another aspect of the present invention pertains to flour, obtainable from a method according to a method outlined hereinbefore. Evidently, such flour can be obtained easily and efficiently on common milling equipment since the legume is not substantially hampered in its physical integrity; moreover, the weight loss of the legume prior to milling is not significant since there is no large sprout. On the other hand, the flour is significantly enhanced in its nutritional composition, as outlined above.

Yet another aspect of the present invention relates to a method of improving the physical quality of splits obtainable after dehusking of legume, and/or to increase the dehusking yield; said method comprising the step of partial germination prior to dehusking, as outlined above. Most surprisingly, it has been found that partial germination as outlined above significantly enhances the physical quality of the splits obtainable from dehusking, as is shown in any detail in the experimental part hereinbelow, compared to splits obtainable without germination (in both cases without any further pre-treatment before dehusking, in order to allow for objective comparability).

Thus, a further aspect of the invention pertains to the use of partial germination for enhancing the physical quality of splits obtainable after dehusking of legume, and/or for increasing the dehusking yield of legume.

A further aspect of the present invention concerns a facility for processing legume, comprising in the direction of the product flow:

means for dehusking and splitting of legume; and

optionally, means for milling splits and/or dehusked pulses;

wherein the facility further comprises means for partial germination of legume upstream of the means for dehusking and splitting of legume.

The means for partial germination of legume preferably comprises malting machinery that is advantageously specifically adapted in order to meet the requirements of legume. In this respect, e.g. the mesh size of the sieve for draining-off excess water, and the tools for moving the legume during germination can be specifically designed for the purpose of treating legume.

The means for partial germination of legume preferably comprises equipment for, in the direction of the product flow,

soaking legume in an aqueous medium, preferably water; and

allowing soaked legume to germinate; and

terminating germination of legume.

Yet another aspect of the present invention pertains to a method of retrofitting a milling facility for legume or a facility for the production of splits, comprising the step of installing means for partial germination of legume upstream of the means for dehusking and splitting of legume. Thus, conventional facilities can be easily upgraded by an add-on of the means for partial germination of the legume, thereby providing significant added value both for the producer and the consumer of the respective foodstuff.

The invention will now be explained in even further detail by means of figures, examples and specific embodiments, without however limiting the scope of the invention to these embodiments:

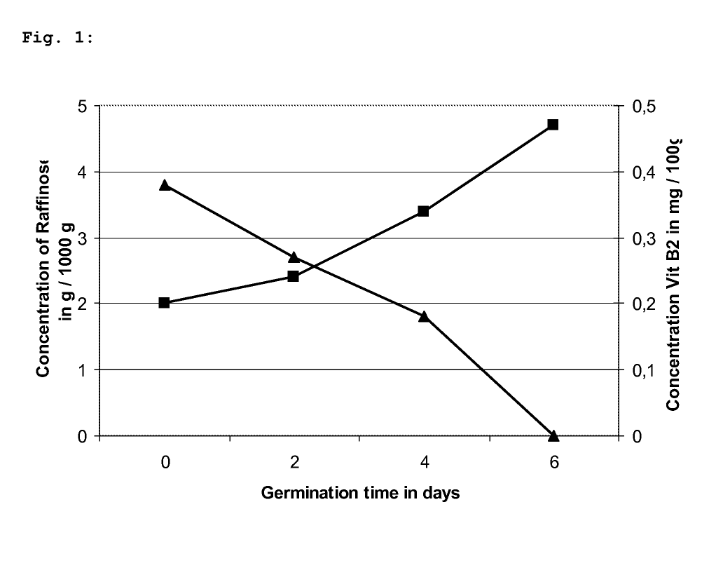

FIG. 1: Concentration of nutrient and antinutrient in legume, depending on the time of germination;

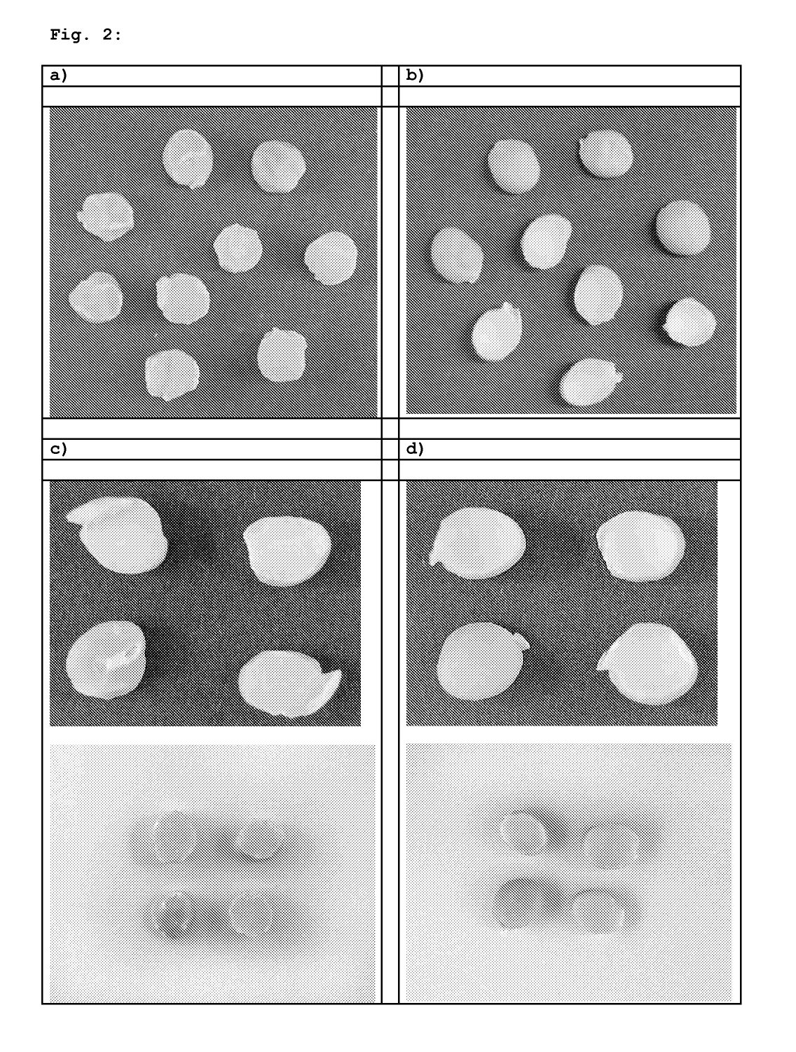

FIG. 2: Quality of splits of brown chickpeas, with (FIG. 2b/d) and without (FIG. 2a/c) partial germination prior to dehusking;

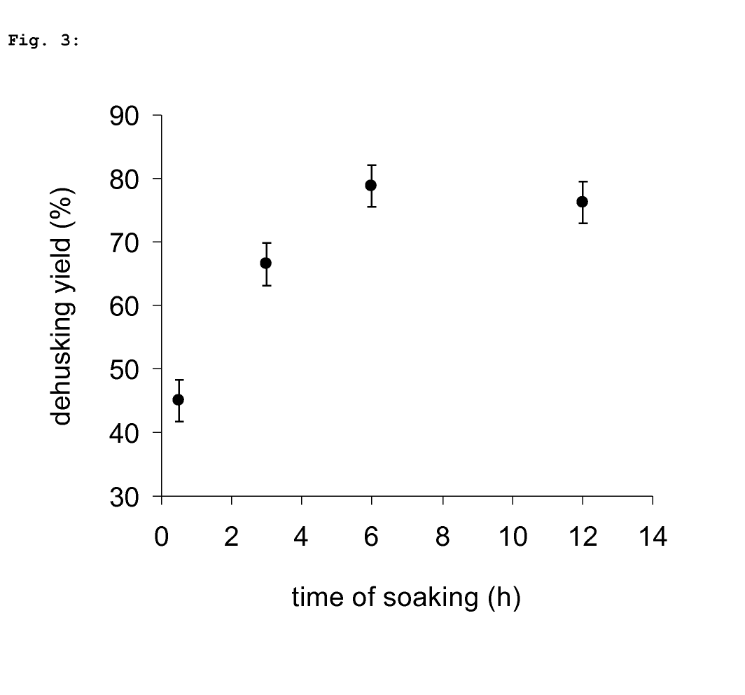

FIG. 3: Dehusking yield, depending on the time of soaking of legume in water.

### A. EFFECT OF GERMINATION ON NUTRIENTS AND ANTINUTRIENTS

The following effects of germination on nutrients and antinutrients of legumes have been observed:

### A.1 Chickpeas

### A.1.1 ROF

Defined as the main α-galactosides found in the pulses: raffinose and stachyose (g/100 g, dry mass (d.m.)).

### Cf Trugo et al., Food Chemistry 65 (1999), 85-90.

### Raw: 2.72±0.01

### Germinated 1 day: 0.98±0.02

Germinated 2 days: 1.57±0.03

The seeds were disinfected with a sodium hypochlorite solution containing 25% (w/v) of chlorine and left soaking for 5 h in distilled water. Malted seeds were obtained by germination during 24 h and 48 h periods in the dark at 30° C. and the seeds were dried in an air oven at 60° C. until reaching 7-12% of moisture. Dried samples were then milled to pass a 100 mm sieve prior to the analyses.

Galactosides were determined based on a procedure previously described (Muzquiz et al., J. Chrom. (1992), 349-362). Ground samples (0.5 g) were extracted with 80% (v/v) methanol for 1 min. The mixture was then centrifuged for 5 min at 3500 g and the supernatant decanted. This procedure was repeated twice and the combined supernatants evaporated to dryness under vacuum at 35° C. The residue was dissolved in double-deionized water (1 ml) and passed through Dowex 50WX8 and Waters QMA minicolumns by means of a Supelco vacuum system. The eluate was then used directly for HPLC. A Beckman HPLC System Gold (USA) consisting of a pump, a refractive index detector and a Rheodyne injection valve (20 ml loop) and an electronic integrator was used. A Lichrosorb-5-NH2 column (250×4.6 mm i.d.) (Merck, Germany) was employed with a mixture of acetonitrile/water (65:35, v/v) at 1 ml/min as the mobile phase. Individual sugars were quantified using external standardization, based on peak areas.

### A.1.2 Protein Digestibility (%)

### Cf Ghavidel et al., LWT 40 (2007), 1292-1299.

### Raw: 64.2±1.8

### Germinated 24 h: 73.4±0.7

Chickpea (Cicer arietinum) were obtained from local market. Legume seeds were cleaned, washed and soaked in 4-5 volumes of water (22-25° C.) for 12 h under ambient laboratory conditions. At the end of the period, the water was drained and the seed samples were allowed to germinate under a wet muslin cloth for 24 h and then dried in a cabinet dryer (Magumps, Mumbai, India) at 50±5° C. for 16-18 h.

In vitro protein digestibility was estimated by enzymatic method of Akeson et al., Journal of Nutrition 83 (1964), 257-261.

### A.1.3 Bioavailable Iron (%)

### Cf Ghavidel et al., LWT 40 (2007), 1292-1299.

### Raw: 11.3±0.2

### Germinated 24 h: 18.6±0.2

Chickpea (Cicer arietinum) were obtained from local market. Legume seeds were cleaned, washed and soaked in 4-5 volumes of water (22-25° C.) for 12 h under ambient laboratory conditions. At the end of the period, the water was drained and the seed samples were allowed to germinate under a wet muslin cloth for 24 h and then dried in a cabinet dryer (Magumps, Mumbai, India) at 50±5° C. for 16-18 h.

An in vitro method for the determination of bioavailability of nonheme iron (i.e. iron from plant sources) from foods was investigated. Sample was extracted with pepsin-HCl at pH 1.35 and subsequently the pH was adjusted to pH 7.5 and filtered. Ionizable iron was determined in the filtrate by the α-α-dipyridyl method. Percent iron bioavailability is predicted using the following regression equation: y=0.4827+0.4707 x, where y is the percent available iron and x is the percent ionizable iron (Rao et al., American Journal of Clinical Nutrition 31 (1978), 169-175).

A.1.4 Vitamin B₁ (Thiamin) (mg/100 g Dry Mass)

### Cf Ghavidel et al., LWT 40 (2007), 1292-1299.

### Raw: 0.34±0.009

### Germinated 24 h: 0.42±0.01

Chickpea (Cicer arietinum) were obtained from local market. Legume seeds were cleaned, washed and soaked in 4-5 volumes of water (22-25° C.) for 12 h under ambient laboratory conditions. At the end of the period, the water was drained and the seed samples were allowed to germinate under a wet muslin cloth for 24 h and then dried in a cabinet dryer (Magumps, Mumbai, India) at 50±5° C. for 16-18 h.

Thiamin was analyzed by oxidation to thiochrome, which fluoresces in UV light (Raghuramulu et al., A manual of laboratory techniques. Jami-Osmania, Hyderabad, India: National Institute of Nutrition, Indian Council for Medical Research (1983)).

A.1.5 Vitamin C (Ascorbic Acid) (mg/100 g Dry Mass)

### Cf Fernandez et al., Plant Foods for Human Nutrition 38 (1988), 127-134.

### Raw: 1.9

### Germinated 24 h: 9.4

### Germinated 48 h: 15.6

Surutato chickpeas from LA Costa de Hermosillo in Mexico (1985 crop) were germinated for 24 and 48 h. Seeds were soaked overnight and placed in slightly dampened germinating paper (Seedburo Equipment Co.) which was placed in shallow plastic or stainless steel containers covered with plastic film to allow the passage of sunlight. Temperature was maintained at 23° C. Germinated and intact chickpeas were autoclaved for 30 min in a Barnstead sterilizer and they where then lyophilized in a Virtis Freeze Dryer for 48 h and ground to 100 mesh flour which was stored at 4° C. prior to analysis.

### A.2 Pigeon Peas

### A.2.1 Bioavailable Zinc (%)

### Cf Duhan et al., Journal of Food Composition and Analysis 17 (2004), 597-604.

### Raw: 68.8±0.14

### Germinated 24 h: 78.0±0.61

### Germinated 36 h: 80.6±0.31

### Germinated 48 h: 81.90±0.71

The seeds of pigeon pea (Cajanus cajan) variety ICPL-87 were procured from the Department of Plant Breeding, College of Agriculture, CCS Haryana Agricultural University and International Crop Research Institute for Semi-Arid Tropics (ICRISAT) Centre, Hisar. The seeds were cleaned of dust, cracked and broken seeds and other foreign material. Raw seeds were ground (0.05 mm sieve) in an electric grinder (Cyclotec, M/s Tecator, Höganäs, Sweden), packed in air-tight containers and were used as control.

The soaked seeds (12 h) were washed and rinsed with distilled water. The seeds were rolled in germination paper kept in an incubator at 30° C. for 24, 36 and 48 h. All the processed seeds were dried in the hot air oven (60° C.) to a constant weight, ground in an electric grinder (Cyclotec, M/s Tecator, Höganäs, Sweden) using 0.5 mm sieve size and packed in air-tight containers for chemical analysis.

One gram of ground sample was taken in a 150 ml conical flask. To this, 25-30 ml diacid mixture (HNO₃:HClO₄; 5:1 v/v) was added and kept overnight. The next day it was digested by heating till clear white precipitates settled down at the bottom. The crystals were dissolved by diluting in double distilled water. The contents were filtered through Whatman #42 filter paper. The filtrate was made to 50 ml with double distilled water and was used for determination of total Zn. Trace minerals viz. zinc in acid digested samples were determined using an AtomicAbsorption Spectrophotometer 2380, Perkin-Elmer (USA) according to the method of Lindsey et al., Agronomy Abstracts 61 (1969), 84. For HCl-extractability, to 1 g sample, 50 ml 0.03 n HCl was added. The mixture was incubated at 37° C. in a shaker-cum-water bath for 3 h to simulate conditions that occur in human stomach. The mixture was then filtered through an ashless filter paper (Whatman #42). The filtrate was oven-dried, digested in the diacid mixture and proceeded for the determination of zinc and copper with an Atomic Absorption Spectrophotometer as mentioned above for total zinc. HCl-extractability of dietary essential minerals in 0.03 n HCl is an index of the bioavailability of the minerals.

A.3 Lentils (Lens Culinaris L, Var. Castellana)
A.3.1 Vitamin B₂ (Riboflavin) (mg/100 g Dry Mass)

### Cf Vidal-Valverde et al., Eur Food Res Technol 215 (2002), 472-477.

### Raw: 0.20±0.01

Germinated 2 days: 0.24±0.01

For every tray in the germinator, 500 g of legume seeds were soaked in 2500 ml of water containing 0.07% sodium hypochlorite solution for 30 min at room temperature. Seeds were then drained off, watered to neutral pH, and soaked in distilled water for 5 h and 30 min. Finally, hydrated seeds were located in six trays and germinated at a pilot scale by layering them over a moist filter paper continuously watered by capillary in a seed germinator (G-120 Snijders, Holland) for 2 days at 20° C., 99% relative atmospheric humidity. Sprouted seeds were freeze-dried and ground to pass through a 0.18 mm sieve for their analysis.

A single extraction procedure for vitamins B1 and B2 was carried out according to Vidal-Valverde et al. (Vidal-Valverde et al., Z Lebensm Unters Forsch 194 (1993), 461). These vitamins were quantified by HPLC as described in previous papers (Vidal-Valverde et al., Z Lebensm Unters Forsch 194 (1993), 461 and Frias et al., J Food Protec 58 (1995), 692).

### A.3.2 Protein Digestibility (%)

### Cf Ghavidel et al., LWT 40 (2007), 1292-1299.

### Raw: 65.6±1.1

### Germinated 24 h: 75.1±1.4

The method is performed as defined in A.1.2.

### A.3.3 Bioavailable Iron (%)

### Cf Ghavidel et al., LWT 40 (2007), 1292-1299.

### Raw: 10.2±0.1

### Germinated 24 h: 18.5±0.2

The method is performed as defined in A.1.3.
A.3.4 Vitamin B₁ (Thiamin) (mg/100 g Dry Mass)

### Cf Ghavidel et al., LWT 40 (2007), 1292-1299.

### Raw: 0.51±0.03

### Germinated 24 h: 0.68±0.04

The method is performed as defined in A.1.4.

### A.3.5 ROF

Defined as the main α-galactosides found in the pulses: raffinose and stachyose (g/100 g, dry basis)

### Cf Vidal-Valverde et al., Eur Food Res Technol 215 (2002), 472-477.

### Raw: 2.15±0.08

Germinated 2 days: 0.27±0.01

For every tray in the germinator, 500 g of legume seeds were soaked in 2500 ml of water containing 0.07% sodium hypochlorite solution for 30 min at room temperature. Seeds were then drained off, watered to neutral pH, and soaked in distilled water for 5 h and 30 min. Finally, hydrated seeds were located in six trays and germinated at a pilot scale by layering them over a moist filter paper continuously watered by capillary in a seed germinator (G-120 Snijders, Holland) for 2 days at 20° C., 99% relative humidity. Sprouted seeds were freeze-dried and ground to pass through a 0.18-mm sieve for their analysis.

Analysis of α-galactosides (raffinose, ciceritol, stachyose and verbascose) was carried out following the method described by Frias et al. (Frias J, Hedley C L, Price K R, Fenwick R G, Vidal-Valverde C (1994) J Liq Chrom 17:2461).

A.3.6 Vitamin B₁ (Thiamin) (mg/100 g d.m.)

### Cf Vidal-Valverde et al., Eur Food Res Technol 215 (2002), 472-477.

### Raw: 0.52±0.03

Germinated 2 days: 0.51±0.02

For every tray in the germinator, 500 g of legume seeds were soaked in 2500 ml of water containing 0.07% sodium hypochlorite solution for 30 min at room temperature. Seeds were then drained off, watered to neutral pH, and soaked in distilled water for 5 h and 30 min. Finally, hydrated seeds were located in six trays and germinated at a pilot scale by layering them over a moist filter paper continuously watered by capillary in a seed germinator (G-120 Snijders, Holland) for 2 days at 20° C., 99% relative humidity. Sprouted seeds were freeze-dried and ground to pass through a 0.18-mm sieve for their analysis. A single extraction procedure for vitamins B1 and B2 was carried out according to Vidal-Valverde et al (Vidal-Valverde C, Frias J, Prodanov M, Tabera J, Ruiz R, Bacon J (1993) Z Lebensm Unters Forsch 194:461). These vitamins were quantified by HPLC as described in previous papers (Vidal-Valverde C, Frias J, Prodanov M, Tabera J, Ruiz R, Bacon J (1993) Z Lebensm Unters Forsch 194:461 and Frias J, Prodanov M, Sierra I, Vidal-Valverde C (1995) J Food Protec 58:692).

### A.4 Black Bean

### A.4.1 ROF

Defined as the main α-galactosides found in the pulses: raffinose and stachyose (g/100 g, dry mass (d.m.)).

### Cf Trugo et al., Food Chemistry 65 (1999), 85-90.

### Raw: 2.77±0.03

### Germinated 1 day: 0.80±0.03

Germinated 2 days: 0.23±0.03
The method is performed as defined in A.1.1.

### A.5 Soybean

A.5.1 ROF

Defined as the main α-galactosides found in the pulses: raffinose and stachyose (g/100 g, dry mass (d.m.)).

### Cf Trugo et al., Food Chemistry 65 (1999), 85-90.

### Raw: 3.14±0.09

### Germinated 1 day: 1.82±0.06

Germinated 2 days: 1.88±0.03
The method is performed as defined in A.1.1.
A.6 Beans (Phaseolus Vulgaris L, Var. La Granja)

### A.6.1 ROF

Defined as the main α-galactosides found in the pulses: raffinose and stachyose (g/100 g, dry basis)

### Cf Vidal-Valverde et al., Eur Food Res Technol 215 (2002), 472-477.

### Raw: 0.61±0.01

Germinated 2 days: 0.25±0.01
The method is performed as defined in 0.
A.6.2 Vitamin B₁ (Thiamin) (mg/100 g d.m.)

### Cf Vidal-Valverde et al., Eur Food Res Technol 215 (2002), 472-477.

### Raw: 0.75±0.02

Germinated 2 days: 0.73±0.03
The method is performed as defined in 0.
A.6.3 Vitamin B₂ (Riboflavin) (mg/100 g Dry Mass)

### Cf Vidal-Valverde et al., Eur Food Res Technol 215 (2002), 472-477.

### Raw: 0.28±0.01

Germinated 2 days: 0.31±0.01
The method is performed as defined in A.3.1.
A.7 Peas (Pisum Sativum L, Var. Esla)

### A.7.1 ROF

Defined as the main α-galactosides found in the pulses: raffinose and stachyose (g/100 g, dry basis)

### Cf Vidal-Valverde et al., Eur Food Res Technol 215 (2002), 472-477.

### Raw: 2.80±0.07

Germinated 2 days: 0.27±0.01
The method is performed as defined in A.6.1.
A.7.2 Vitamin B₁ (Thiamin) (mg/100 g d.m.)

### Cf Vidal-Valverde et al., Eur Food Res Technol 215 (2002), 472-477.

### Raw: 0.74±0.04

Germinated 2 days: 0.75±0.02
The method is performed as defined in A.6.2.
A.7.3 Vitamin B₂ (Riboflavin) (mg/100 g Dry Mass)

### Cf Vidal-Valverde et al., Eur Food Res Technol 215 (2002), 472-477.

### Raw: 0.15±0.03

Germinated 2 days: 0.24±0.01
The method is performed as defined in A.3.1.

### A.8 Green Gram (Phaseolus Aureus)

### A.8.1 ROF

Defined as the main α-galactosides found in the pulses: raffinose and stachyose (g/100 g, dry basis)

### Cf Java et al., Food Chemistry 7 (1981) 95-104.

### Raw: 5.43±0.01

Germinated 2 days: 2.66±0.01

Green gram were soaked in water for 4 h and germinated in the dark on moist vermiculite at between 25 and 27° C. The seedlings were harvested at 48-h and 96-h intervals, freeze-dried and ground to a fine powder. Starch and total sugars were estimated as glucose equivalents (McCready et al., 1950) and reducing sugars were determined using 3,5-dinitro salicyclic acid (Bernfeld, 1954). Pentosans were precipitated as the phloroglucinol derivatives and estimated gravimetrically (AOAC, 1970). The ethanol-soluble sugars were extracted from the legume flour by repeated shaking with 70% ethanol and the extracts were pooled. The extractions were repeated until the final extract showed a negative test for sugars. The ethanol was evaporated from the pooled extracts under vacuum at 40° C., then deionized by shaking the extract with Dowex 50 (H+form, 200 to 300 mesh) and concentrated under vacuum. A known volume of the concentrated extract was adsorbed on a carbon-celite (1:1) column and sugars were eluted with different concentrations of alcohol (up to 30%) as suggested by Whistler & Be Miller (1962). The eluted sugars were then concentrated and further separated and identified using descending paper chromatography. Oligosaccharides were separated on Whatman No. 3 paper by developing the chromatogram for 4 h using propanol-ethanol-water (7:1:2). Monosaccharides were separated by developing the chromatogram for 12 h using an ethyl acetate-pyridine-water system (8:2:1). An attempt was made to identify unknown sugars by partial acid and enzymic hydrolysis and also by determining their specific rotation using a Highler standard polarimeter.

### A.8.2 Bioavailable Iron (%)

### Cf Ghavidel et al., LWT 40 (2007), 1292-1299.

### Raw: 10.9±0.1

### Germinated 24 h: 18.3±0.2

The method is performed as defined in A.1.3.
A.8.3 Vitamin B₁ (Thiamin) (mg/100 g Dry Mass)

### Cf Ghavidel et al., LWT 40 (2007), 1292-1299

### Raw: 0.56±0.02

### Germinated 24 h: 0.71±0.03

The method is performed as defined in A.1.4.

### A.8.4 Protein Digestibility (%)

### Cf Ghavidel et al., LWT 40 (2007), 1292-1299.

### Raw: 61.0±1.0

### Germinated 24 h: 72.7±0.8

The method is performed as defined in A.1.2.

### A.9 Cowpea

### A.9.1 Bioavailable Iron (%)

### Cf Ghavidel et al., LWT 40 (2007), 1292-1299.

### Raw: 11.2±0.3

### Germinated 24 h: 19.7±0.2

The method is performed as defined in A.1.3.
A.9.2 Vitamin B₁ (Thiamin) (mg/100 g Dry Mass)

### Cf Ghavidel et al., LWT 40 (2007), 1292-1299

### Raw: 0.64±0.02

### Germinated 24 h: 0.69±0.03

The method is performed as defined in A.1.4.

### A.9.3 Protein Digestibility (%)

### Cf Ghavidel et al., LWT 40 (2007), 1292-1299.

### Raw: 63.8±0.6

### Germinated 24 h: 72.9±1.0

The method is performed as defined in A.1.2.

### A.10 Brown Chickpeas

A sample of brown chickpeas from a harvest in 2010 was obtained from a local market in Mysore in India. Samples of partially germinated brown chickpeas splits were prepared as described in the following procedure. Brown chickpeas were soaked in water for about 12 hours under ambient laboratory conditions. At the end of the period, the water was drained and the seed samples were allowed to germinate under a wet muslin (or cotton) cloth up to two days at ambient conditions and then dried to about 10% MC. The dried seeds were fed in a Grain testing mill and dehulled.

A comparative sample was prepared as above, however without the step of partial germination and drying.

### A.10.1 Moisture, Fat, Protein, Ash and Fiber

Moisture, fat, protein, ash, carbohydrate and fiber determination of the partially germinated brown chickpea splits as well as of the non-germinated comparative example was carried out by standard AOAC procedures 945.38 and 979.09. No statistically relevant difference was noticed between the partially germinated sample and the non-germinated sample in the chemical composition in respect of the above mentioned parameters moisture, fat, protein, ash, carbohydrate and fiber.

### A.10.2 Sugar

Sugar analysis was estimated using HPLC with refractive index detector using standard sugars for calibration. Fructose has greatly increased in the partially germinated samples, as can be seen from Table 2 below; this increase provides a sweet note to the taste. ROF, which are undesired due to their known flatulence discomfort effect, have starkly reduced or even disappeared in the germinated samples, as can also be derived from Table 2.

### A.10.3 Antinutrients

Trypsin inhibitor activity was estimated by the method of Hamerstarnd et al. Phytic acid may be determined as phytin-phosphorous (multiplying the phytin phosphorous value by 3.55) by the method of Thompson and Erdman (1982). Phenolic compounds may be determined as tannin. Tannin was estimated by the modified vanillin assay of Price et al. (1978), using catechin as the standard. These antinutrients in the germinated samples have also strongly reduced; this increased the minerals bioavailability as consequence, as can be deferred from Table 2.

### A.10.4 Minerals

Iron, zinc and calcium were estimated using atomic absorption spectroscopy. Bioaccessible iron, zinc and calcium were determined by an in vitro method described by Luten et al. (1996) involving simulated gastrointestinal digestion with suitable modifications, as described above. No statistically relevant difference between the partially germinated sample and the non-germinated sample was noticed in the total composition of the above mentioned minerals. The bioavailability of iron, zinc and calcium has however remarkably increased in the germinated samples, as can be seen from Table 2.

### A.10.5 Vitamins

Vitamins content may be determined using HPLC methods.

The concentration of the analyzed vitamins has increased several times in the germinated samples, as can be seen from Table 2.

TABLE 2
nutritive value

| | | partially |
|---|---|---|
| | | germinated |
| | | sample |
| | | (relative |
| | non-germinated sample | change) |
| Sugars: | | |
| fructose | 1.8 g/100 g d.m. | +250% |
| Oligosaccharides: | | |
| ROF | 4.0 g/100 g d.m. | −100% |
| Antinutritional factors: | | |
| trypsin inhibitors activity | 5072 ± 14.8 U/g d.m. | 35% |
| phytic acid | 0.854 ± 0.065 g/100 g d.m. | 12% |
| phenolic compounds | 1.210 ± 0.038 g/100 g d.m. | −5% |
| Minerals: | | |
| absolute bioaccessible iron | 0.065 ± 0.007 mg/100 g d.m. | +150% |
| relative bioaccessible iron | 2.07% of total iron | |
| absolute bioaccessible zinc | 0.55 ± 0.004 mg/100 g d.m. | +60% |
| relative bioaccessible zinc | 24.1% of total zinc | |
| Vitamins: | | |
| thiamine (B1) | 0.18 mg/100 g d.m. | +500% |
| riboflavin (B2) | 0.11 mg/100 g d.m. | +10% |

### B. CONTENT OF NUTRIENTS AND ANTINUTRIENTS, DEPENDING ON THE TIME OF GERMINATION

As is shown in FIG. 1, the content of nutrients (e.g. vitamin B2, ▪) increases and the content of antinutrients (e.g. raffinose, ▴) decreases during the course of germination (cf e.g. Vidal-Valverde et al., Eur Food Res Technol 215 (2002), 472-477).

TABLE 3

| | Vitamin B₂ | Raffinose |
|---|---|---|
| Time of germination | (mg/100 g | (g per 1000 g |
| (days) | d.m.) | d.m.) |
| 0 | 0.20 | 3.8 |
| 2 | 0.24 | 2.7 |
| 4 | 0.34 | 1.8 |
| 6 | 0.47 | — |

Besides these known effects of germination, the present invention for the first time applies partial germination for the purpose of improving the nutritional quality of splits and flour, and to improve the physical quality of splits and the dehusking yield, as outlined below.

### C. EFFECT OF GERMINATION ON DEHUSKING YIELD AND QUALITY OF SPLITS

The following experimental procedure was used to obtain experimental data and samples shown in FIGS. 2 and 3.

Brown chickpeas were cleaned, washed and soaked in 5 volumes of water (22-25° C.) for different times under ambient laboratory conditions. At the end of the period, the water was drained and the seed samples were allowed to germinate under a wet muslin (or cotton) cloth for 24 h at ambient conditions and then dried to about 10% MC in a cabinet dryer at 50° C. for 16 h. The dried seeds were fed in batches of 100 g in an Indosaw Grain testing mill and milled for 20 seconds.

The processed seeds were divided (by hand) in six different fractions: head product (dhal (Indian-language term for split grains), gota (Indian-language term for whole grains)), unhusked seeds, brokens, husks (i.e. hulls), powder; each fraction was weighed and the dehusking yield was calculated. The dehusking yield of the process is defined as the weight of head product produced divided by the weight of the raw material processed.

In FIG. 2, the comparison between dhals obtained by direct milling the raw material without pre-treatment (FIG. 2a and FIG. 2c, in higher resolution) and the same material milled after the treatment according to the invention (FIG. 2b and FIG. 2d, in higher resolution) as described above (with 6 hours soaking) is reported. In both cases, no further pre-treatment was used to enhance physical quality of the splits. The improved physical quality of the splits according to the invention (FIG. 2b/d) compared to splits obtained by direct milling without pre-treatment (FIG. 2a/c) is immediately evident.

In FIG. 3 the dehusking yield in function of the duration of soaking in water is reported. It is evident that the dehusking yield increased after e.g. 6 h of soaking and subsequent 24 h of germination increased from about 45% to about 80%, thus providing significant added-value for the manufacturer of splits.

It was found that partial germination improves the milling properties of brown chickpeas. In particular, with samples obtained with the procedure described in paragraph A.10, the dehusking yield increases from 75.8% (untreated-raw brown chickpeas) up to 81.8%. Moreover, partially germinated samples are more yellow in colour than raw samples, while hardness is lower and shape also becomes slightly curved. Cooking properties assessment showed that the partial germination increases the cooking time and decreases the quantity of dispersed solids. In addition, the sensory assessment showed that the partially germinated dhal were sweeter than the reference sample (non-germinated dhal) but with a slightly paler colour.

1-16. (canceled)

17. A method of preparing flour or splits of legume, comprising the steps of:
i) providing legume;
ii) allowing the legume to partially germinate;
iii) preparing the partially germinated legume for milling.

18. A method according to claim 17, comprising between step ii) and step iii) the additional step:
iia) terminating germination of the legume;

19. A method according to claim 17, comprising after step iii) the additional step:
iiia) milling the prepared legume of step iii).

20. A method according to claim 17, wherein the partial germination in step ii) is carried out for a time and under conditions sufficient to allow for at least one antinutrient to decrease by about 5% to about 90%.

21. A method according to claim 20, wherein the antinutrient is selected from the group consisting of trypsin inhibitor, phytic acid and phenolic compounds.

22. A method according to claim 17, wherein the legume is pulse and the partial germination in step ii) is carried out for a time and under conditions sufficient to result in an ROF content of about 0.1 g to about 3.0 g per 100 g dry mass.

23. A method according to claim 17, wherein the legume is pulse and the partial germination in step ii) is carried out for a time and under conditions sufficient to result in a bioavailability of iron of the pulse in the range of about 15% to about 35% of total iron.

24. A method according to claim 17, wherein the legume is pulse and the partial germination in step ii) is carried out for a time and under conditions sufficient to result in a bioavailability of zinc of the pulse in the range of about 75% to about 95% of total zinc.

25. A method according to claim 17, wherein the legume is pulse and the partial germination in step ii) is carried out for a time and under conditions sufficient to result in a protein digestibility of the pulse in the range of about 70% to about 90%.

26. A method according to claim 17, wherein step ii) of allowing the legume to partially germinate comprises the sub-steps of:
a) soaking the legume in an aqueous medium;
b) conditioning the soaked legume.

27. A method according to claim 26, wherein the sub-step b) of conditioning the soaked legume is carried for about 6 h to about 36 h.

28. A method according to claim 18, wherein step iia) of terminating germination of the legume is carried out by a method chosen from the group consisting of freezing; drying; modifying ambient atmosphere.

29. A method according to claim 17, wherein step iii) of preparing the partially germinated legume for milling comprises the sub-steps of:
dehusking;
splitting.

30. A method according to claim 17, wherein the legume is pulse.

31. Flour, obtainable from a method of preparing flour or splits of legume, the method comprising the steps of:
i) providing legume;
ii) allowing the legume to partially germinate;
iv) preparing the partially germinated legume for milling.

32. A method of improving the physical quality of splits obtainable after dehusking of legume, comprising the step of partial germination prior to dehusking.

33. A method of increasing the dehusking yield of legume, comprising the step of partial germination prior to dehusking.

34. Splits of legume, the legume having been subjected to partial germination prior to dehusking.

35. A facility for processing legume, comprising means for dehusking and splitting of legume;
wherein the facility further comprises means for partial germination of legume upstream of the means for dehusking and splitting of legume.

36. A method of retrofitting a milling facility for legume or a facility for the production of splits, comprising the step of installing means for partial germination of legume upstream of the means for dehusking and splitting of legume.
